(19) United States
(12) Patent Application Publication
(10) Pub. No.: US 2023/0194299 A1
(43) Pub. Date: Jun. 22, 2023

(54) MAP PROVIDING SYSTEM

(71) Applicant: Hitachi Astemo, Ltd., Hitachinaka-shi, Ibaraki (JP)

(72) Inventor: Susumu MIKASA, Tokyo (JP)

(73) Assignee: Hitachi Astemo, Ltd., Hitachinaka-shi, Ibaraki (JP)

(21) Appl. No.: 17/926,943

(22) PCT Filed: Apr. 27, 2021
(86) PCT No.: PCT/JP2021/016723

§ 371 Date: Nov. 21, 2022

(30) Foreign Application Priority Data
Jul. 22, 2020 (JP) 2020-125109

(51) Int. Cl. G01C 21/00; G01C 21/32

(52) U.S. Cl. CPC G01C 21/3815; G01C 21/32

(57) ABSTRACT

An object of a map providing system of the present invention is to specify a range of map data that may be newly prepared, and to increase an opportunity to use a latest map. A map providing system compares route information or road information on a first map stored in a first map storage portion (71) with road information on a second map stored in a second map storage portion (21), selects an update point of the second map on the basis of road information not included in the second map, and requests a map OTA server 5 that manages latest update data of the second map to provide the update data of the update point of the second map.

### TECHNICAL FIELD

The present invention relates to a map providing system that provides, for example, map information.

### BACKGROUND ART

The importance of the map referred to in the automatic driving of the vehicle is high. Therefore, it is required to reliably acquire the latest map information used by the electronic control device in a timely manner according to the latest maintenance situation of the map.

Background art of the present technical field includes the following prior art. PTL 1 (JP 2011-257298 A) discloses a map data acquisition system including an own vehicle position detection unit, a cruisable distance acquisition unit, and a map data request unit that requests a server for map data by transmitting an own vehicle position detected by the own vehicle position detection unit and a cruisable distance acquired by the cruisable distance acquisition unit at a map data request timing, in which the server transmits map data to a navigation device limited to map data corresponding to a cruisable region that is considered to be cruisable by the own vehicle according to the own vehicle position and the cruisable distance in response to the request for map data (see Abstract).

PTL 2 (JP 2003-14472 A) discloses a communication device connected to a server that distributes map information, a map acquisition device that acquires map information from the server, a display that displays an image of a map based on the acquired map information, a position measurement device that measures a position of a mobile body, an update time calculation device that calculates an update time necessary for map update including a time for acquiring the map information, a movement distance calculation device that calculates a movement distance of the mobile body during map update, a road distance calculation device that calculates a road distance by which the mobile body travels from a current position to an edge of the map, a comparison device that compares the road distance with the movement distance, and a map clipping range setting device that sets a range of a map to be displayed next when the road distance coincides with the movement distance, a navigation system configured to transmit map range information set by the map clipping range setting unit to the server via the communication unit, acquire new map information from the server, and update a map displayed as an image by the display (see claim 1).

PTL 3 (JP 2006-276451 A) discloses a method in which, in a navigation device capable of partially updating map data, a road that is included in the latest data of route calculation data used for cost calculation of a route but is not included in road data before update recorded in a storage device is set as a newly constructed main road, the periphery of the main road is set as an update target region, updated map data of the set region is downloaded from an updated map data distribution center to a navigation device, and map data recorded in the storage device is partially updated (see Abstract).

Citation List

Patent Literature

PTL 1: JP 2011-257298 A

PTL 2: JP 2003-14472 A

PTL 3: JP 2006-276451 A

### SUMMARY OF INVENTION

Technical Problem

In a map providing system that constantly updates a high precision map for automatic driving, in a case where a planned travel route for automatic driving includes an area for which a high precision map is not prepared, or in a case where a planned travel route for automatic driving includes an area for which a high precision map is prepared but is not recorded in a map held by the system, the map providing system cannot provide map information, and therefore, automatic driving cannot be used. Therefore, in order to promote the use of the automatic driving, it is desirable to preferentially reflect the map data of the region where the high precision map is newly prepared in the map providing system and expand the range in which the automatic driving can be used.

In the conventional navigation devices such as PTL 1 and PTL 3 described above, for example, a range to be updated in map data is selected on the basis of a position of an own vehicle, a highway included in navigation map data, and route data of a planned travel. However, in these processes, the latest high-precision map data for automatic driving that has been newly prepared cannot be specified and selected as a target to be preferentially updated, and there is a possibility that unnecessary update processing is performed by selecting a target that does not need to be updated. Since there may be a case where the high precision map data for automatic driving included in the map providing system does not include a main road or travel route data that can be used as a reference, the reference itself may not be set.

An object of the present invention is to increase an opportunity to use a newly developed latest map by giving priority to an area for which high-precision map data is not recorded and checking whether the latest map data can be updated, and to expand a range in which automatic driving can be used and promote the use.

Solution to Problem

A representative example of the invention disclosed in the application is as follows. That is, a map providing system that provides map data, includes: a first map storage portion that stores a first map; a second map storage portion that stores a second map; and a map update portion that updates the second map stored in the second map storage portion when the update data is provided from a management device that manages update data of the second map. The map update portion selects an update point to update map data on the second map based on a difference obtained by comparing the first map stored in the first map storage portion with the second map stored in the second map storage portion, and requests the management device to provide update data of the selected update point.

Advantageous Effects of Invention

According to one aspect of the present invention, it is possible to select an unprepared or unrecorded area on the second map as a location to be updated and check whether the latest map data is updated with the management device that manages the update data of the second map. Therefore, it is possible to increase the opportunity to use the latest map that has been newly prepared, and it is possible to expand the range in which the automatic driving can be used and promote the use. Objects, configurations, and effects besides the above description will be apparent through the explanation on the following embodiments.

Other features of the invention will be clear from the description and the accompanying drawings. In addition, objects, configurations, and effects besides the above description will be apparent through the explanation on the following embodiments.

### BRIEF DESCRIPTION OF DRAWINGS

FIG. 1 is a diagram illustrating a configuration of a map providing system according to the present embodiment.

FIG. 2 is a flowchart of processing executed by a map ECU.

FIG. 3 is a diagram illustrating an example of a difference between first map data and second map data.

FIG. 4 is a diagram illustrating an example of selecting an update range by comparing route information of the first map data with road information of the second map data.

FIG. 5 is a diagram illustrating an example of selecting an update range by comparing road information of the first map data with road information of the second map data.

### DESCRIPTION OF EMBODIMENTS

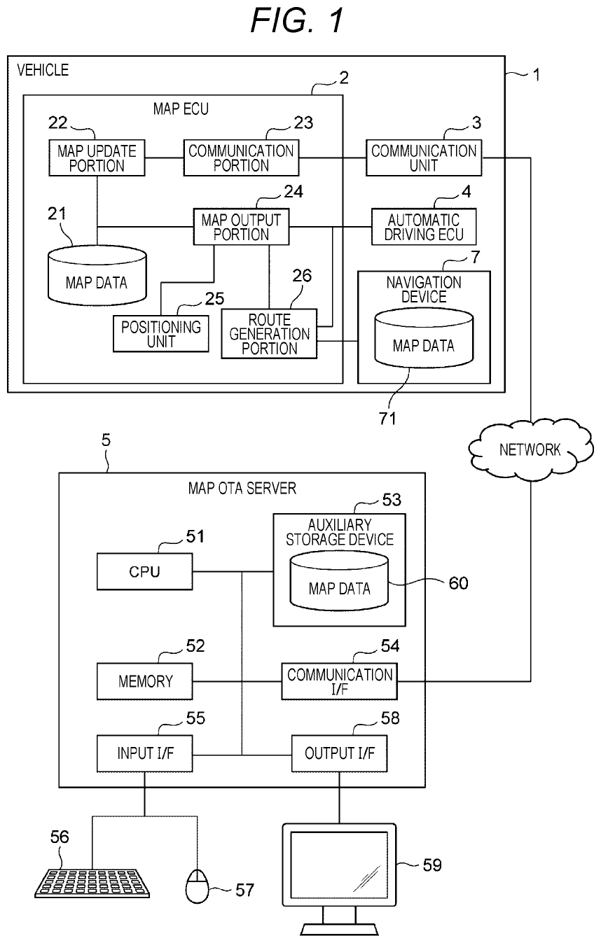

FIG. 1 is a diagram illustrating a configuration of an embodiment to which a map providing system of the present invention is applied.

The map providing system includes a map ECU 2 as a map data management device and a map OTA server 5 as a map data management server. The map ECU 2 and the map OTA server 5 are connected via a communication unit 3 mounted on a vehicle 1. The map ECU 2 is mounted on a vehicle and is connected to an external map OTA server 5 via a network. The map ECU 2 is connected to an automatic driving ECU 4 by a communication means such as a controller area network (CAN).

A navigation device 7 includes a first map storage portion 71 that stores a first map, and creates a route for guiding the vehicle to a destination using the first map stored in the first map storage portion 71. The first map includes information for guiding the vehicle to the destination.

The map OTA server 5 constitutes a management device that manages update data of a second map to be described later. The computer constituting the map OTA server 5 includes a processor (CPU) 51, a memory 52, an auxiliary storage device 53, and a communication interface 54. The computer may have an input interface 55 and an output interface 58. The processor (CPU) 51, the memory 52, the auxiliary storage device 53, the communication interface 54, the input interface 55, and the output interface 58 are connected to be accessible by a communication means such as a bus.

The processor 51 is an arithmetic device that executes a program stored in the memory 52. The processor 51 executes various programs. Specifically, the program is read from the auxiliary storage device 53, loaded into the memory 52, and executed by the processor 51 to implement each function of the map OTA server 5. A part of the processing performed by the processor 51 executing the program may be executed by another arithmetic device (for example, an arithmetic element by hardware such as FPGA and ASIC).

The memory 52 includes a ROM which is a nonvolatile storage element and a RAM which is a volatile storage device. The ROM stores an invariable program (for example, BIOS) and the like. The RAM is a high-speed and volatile storage device such as a dynamic random access memory (DRAM), and temporarily stores a program executed by the processor 51 and data used when the program is executed.

The auxiliary storage device 53 is, for example, a large-capacity nonvolatile storage device such as a magnetic storage device (HDD) or a flash memory (SSD). The auxiliary storage device 53 stores data used when the processor 51 executes the program and the program executed by the processor 51. For example, the auxiliary storage device 53 stores map data 60. The map data 60 is transmitted to the map ECU 2.

The communication interface 54 is a network interface device that controls communication with other devices according to a predetermined protocol. The input interface 55 is an interface to which input devices such as a keyboard 56, a mouse 57, and a touch panel (not illustrated) are connected and which receives an input from an operator. The output interface 58 is an interface to which an output device such as a display device 59 or a printer (not illustrated) is connected and which outputs an execution result of a program in a format that can be visually recognized by an operator.

The program executed by the processor 51 is provided to the map OTA server 5 via a removable medium (CD-ROM, flash memory, etc.) or a network, and is stored in the nonvolatile auxiliary storage device 53 that is a non-transitory storage medium. Therefore, the map OTA server 5 may have an interface for reading data from a removable medium.

The map OTA server 5 is a computer system configured on physically one computer or on a plurality of computers configured logically or physically, and may operate on a virtual computer constructed on a plurality of physical computer resources.

The map ECU 2 includes a second map storage portion 21, a map update portion 22, a communication portion 23, a map output portion 24, a positioning unit 25, and a route generation portion 26, and manages map data of the second map. The map data of the second map managed by the map ECU 2 is highly accurate map data including, for example, information for each lane of a road for automatic driving and driving support, and is transmitted to the automatic driving ECU 4. The map data of the second map may include data of roads (for example, a highway, a motor way) other than roads (for example, a general road) that can provide automatic driving and driving assistance.

The map ECU 2 determines whether the vehicle is on the posted road included in the map data of the second map by using the position information of the own vehicle measured by the positioning unit 25 and the external information acquired by a sensor, selects the map data of the second map around the own vehicle, and transmits the map data to the automatic driving ECU 4. The map ECU 2 causes the route generation portion 26 to generate detailed route information for the vehicle 1 to automatically drive using the route generated by the navigation device 7, and transmits the route information to the automatic driving ECU 4.

The second map storage portion 21 acquires update data of the second map from the map OTA server 5 and stores the update data in a predetermined storage area. The second map is managed in units of segments. That is, the map data of the second map is acquired from the map OTA server 5 in units of segments.

The map update portion 22 acquires map data of the latest second map in a predetermined range (for example, 5 km around the own vehicle position, 1 km around the route, a range that can be reached in 5 minutes, and the like) from the map OTA server 5. The communication portion 23 controls communication between the map ECU 2 and other devices. The map output portion 24 selects map data of the second map required by the automatic driving ECU 4 and transmits the map data to the automatic driving ECU 4. The positioning unit 25 includes a GNSS receiver that acquires position information of the own vehicle. The positioning unit 25 may not be provided in the map ECU 2, and the position information of the own vehicle may be acquired independently or from a GNSS receiver provided in another ECU.

The communication unit 3 is a communication device that connects a device in the vehicle 1 and an external device via a wireless communication line. A mobile phone network (5G, 4G, etc.), WiFi, or the like can be used as the wireless communication line (network).

In accordance with the route information generated by the map ECU 2, the automatic driving ECU 4 operates a steering wheel, an accelerator, and a brake using external information acquired by a sensor (camera, radar, LIDAR, etc.) mounted on the vehicle to control traveling of the vehicle. That is, the automatic driving ECU 4 provides at least one of an automatic driving function of traveling the vehicle without the operation of the driver and a driving support function of supporting the operation of the driver to travel the vehicle.

In the map providing system of the present embodiment, processing of comparing the route information or the road information on the first map stored in the first map storage portion 71 with the road information on the second map stored in the second map storage portion 21 is performed. Then, processing of selecting an update target of the map data of the second map on the basis of the road information of the second map not recorded in the second map storage portion 21 and receiving and updating the map data from the map OTA server 5, which is a management device that manages the latest update data of the second map, is performed.

Hereinafter, specific contents of processing performed by the map providing system of the present embodiment will be described in detail.

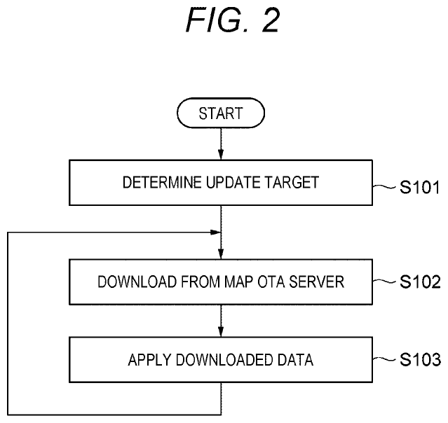

FIG. 2 is a flowchart of processing executed by the map ECU 2. The processing illustrated in FIG. 2 is executed when the ignition switch of the vehicle 1 is turned on and the map ECU 2 is powered on.

First, the map ECU 2 determines a target to be updated in the map data of the second map (Step S101). Specifically, the map ECU 2 inquires of the map OTA server 5 about the current latest version of the map data of the second map, and compares the current latest version with the version of the map data of the second map held therein. As a result, if the version of the map data of the second map held by the second map storage portion 21 is the same as the latest version acquired from the map OTA server 5, the map data of the second map held is the latest, and thus the processing is terminated without acquiring the map data from the map OTA server 5.

On the other hand, when the version of the map data of the second map held by the second map storage portion 21 is different from the latest version acquired from the map OTA server 5, a list of segments of the second map updated after the previous synchronization is acquired from the map OTA server 5. The map ECU 2 determines a segment to be an update target range according to a predetermined rule. Further, the map ECU 2 compares the acquired list with the version of the segment within the determined update range, determines a segment (segment whose version number is old and which can be updated to the latest version) in which the map data is to be updated, and selects the number.

In order to determine the update range, various rules can be adopted, for example, (1) a method of comparing differences between route information generated using map data of the first map of the navigation device 7 and road information of map data of the second map of the map ECU 2, and (2) a method of comparing differences between road information of map data of the first map of the navigation device 7 and road information of map data of the second map of the map ECU 2. Details of each method will be described later.

Next, the map ECU 2 transmits the number of the selected segment to be updated to the map OTA server 5, and requests map data of the segment to be updated. The map OTA server 5 selects map data of the segment requested from the map ECU 2 from the auxiliary storage device 53, and transmits the map data as update data of the second map to the map ECU 2 The map ECU 2 receives map data, which is the requested update data of the second map, from the map OTA server 5 (Step S102).

Thereafter, the map ECU 2 updates the map data of the second map in the second map storage portion 21 using the update data of the second map downloaded and acquired from the map CIA server 5 (Step S103). For example, differential update is performed to store the data of the segment acquired from the map OTA server 5 in the second map storage portion 21. Instead of the differential update, the map ECU 2 may acquire data of all the segments in the update range from the map OTA server 5, and perform overwrite update to store all the data acquired from the map OTA server 5 in the second map storage portion 21.

Next, details of a method for determining map data to be updated in Step 101 will be described.

(1) In the method of difference comparison between the route information generated from the map data of the first map stored in the first map storage portion 71 of the navigation device 7 and the road information of the second map held in the second map storage portion 21 of the map ECU 2, identification information of the road constituting the route information is compared with identification information of the road information existing in the second map held in the map ECU 2, and when the road information constituting the route information does not exist in the second map stored in the second map storage portion 21, there is a possibility that the road existing in the first map does not exist in the second map and the road is newly registered in the latest map data 60 stored in the map OTA server 5. A segment including different roads is determined as an update range.

In the present embodiment, the comparison of the road information is performed by the map ECU 2, but the present invention is not limited thereto, and the comparison may be performed by the map OTA server 5. For example, route information and road information to be compared are transmitted to the map OTA server 5 through the communication portion 23 of the map ECU 2, and comparison processing is performed using the CPU 51, the memory 52, and the like provided in the map OTA server 5. Then, the map update portion 22 may determine the update range on the basis of the comparison result via the communication portion 23 again. The processing load of the map ECU 2 can be reduced by performing the comparison processing of the road information not by the map ECU 2 but by the map OTA server 5.

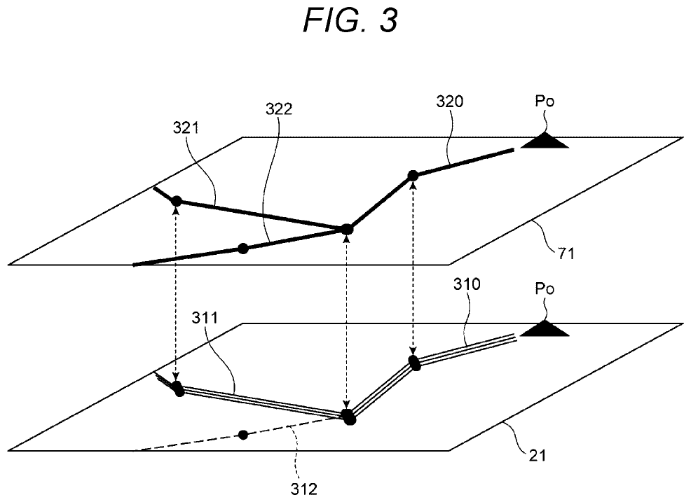

FIG. 3 illustrates an example of a case where a difference is confirmed in the comparison between the route information in the first map storage portion 71 and the road information in the second map storage portion 21.

In FIG. 3, the first map stored in the first map storage portion 71 and the second map stored in the second map storage portion 21 are illustrated by being divided into upper and lower layers. As illustrated in the layer of the first map, the first map storage portion 71 includes data of a road 320 extending from an own vehicle position Po of the vehicle 1 and roads 321 and 322 bifurcating ahead of the road. As illustrated in the layer of the second map, the second map storage portion 21 stores only data of a road 310 extending from the own vehicle position Po of the vehicle 1 and a road 311 continuous thereafter, and does not store data of a road 312 corresponding to the road 322 of the first map. That is, the data of the road 312 exists as the road 322 on the first map used by the navigation device 7, but is not stored in the second map storage portion 21, and is a difference range between the first map and the second map.

Therefore, when a route passing through the road 322 is generated by the navigation device 7, the map update portion 22 can confirm the presence of the road 312 not recorded in the second map as the difference by comparing the route set based on the first map with the road of the second map. Then, the segment of the second map including the road 312 is selected as an update point to be updated in the second map.

In the comparison between the route information and the road information, an identifier of the road information of the first map stored in the first map storage portion 71 and an identifier of the road information of the second map stored in the second map storage portion 21 may be common, and the presence or absence of the identifier may be compared. Alternatively, it may be confirmed whether there is a place where the information of the latitude and longitude of a predetermined point included in the route information matches the road information.

In the comparison between the route information and the road information, for the route information in which there is a difference from the road information, a segment including a branch road or a junction road may be selected as an update point from the information of a branch point or a junction point included in the route information. There is a high possibility that newly maintained map data exists also for roads derived from different roads, and there is a high possibility that newly maintained latest map data can be acquired in a wider range.

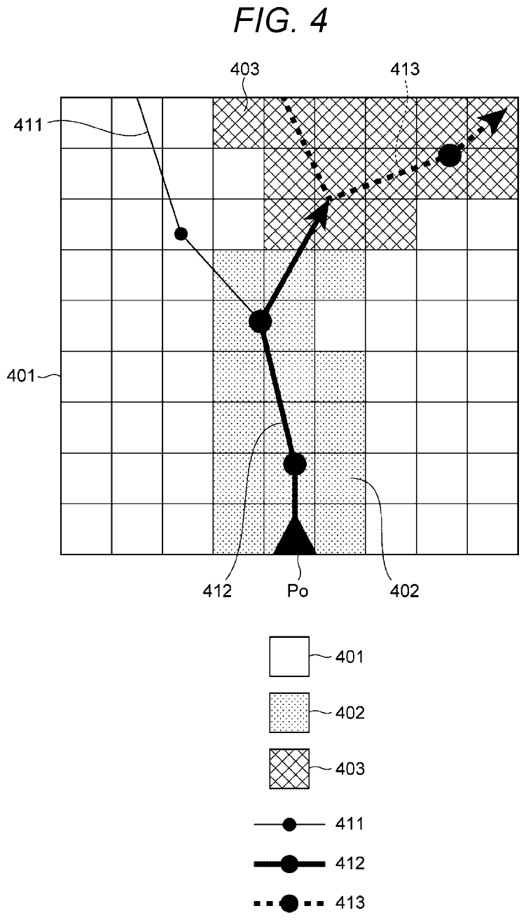

FIG. 4 illustrates an example in which an update target is selected by difference comparison between route information generated from map data of a first map stored in the first map storage portion 71 of the navigation device 7 and road information of a second map stored in the second map storage portion 21 of the map ECU 2.

In FIG. 4, a thin solid line 411 represents road data stored in the second map storage portion 21, and a thick solid line 412 represents a route generated from the map data of the second map. A broken line 413 is a route generated using the first map stored in the first map storage portion 71, and includes a road that does not exist in the second map. A segment 401 is obtained by partitioning a map into a predetermined range, a segment 402 is a segment in which map data has been recorded in the second map storage portion 21, and a segment 403 is a segment in which map data has not been recorded in the second map storage portion 21 and which has been selected as an update point.

FIG. 4 illustrates a case where, for example, a route including the road 413 is set as a route from the own vehicle position Po to the destination by the navigation device 7, but only road data of the road 411 from the own vehicle position Po is stored in the second map storage portion 21, and map data corresponding to the route 413 is not recorded. According to the present embodiment, the segment 403 including the road 413 is selected as the update point for updating the map data on the second map by the comparison difference between the first map stored in the first map storage portion 71 and the second map stored in the second map storage portion 21. Then, the map ECU 2 requests the map OTA server 5 to provide update data.

In the map update portion 22, for example, the segment 403 that is not selected as the target range in the route information configured by the high-precision map data generated by the second map storage portion 21 illustrated in FIG. 4 is selected as the target range (update point) to be updated by referring to the route information in the map data of the first map stored in the first map storage portion 71.

The map ECU 2 selects a segment including a road that exists in the first map data but does not exist in the map data of the second map as an update target range, and requests the map OTA server 5 to provide update data of the selected update target range. Then, in a case where update data exists in the map OTA server 5, the update data is downloaded from the map OTA server 5, and the map data of the second map is updated. Therefore, the map ECU 2 can add new road information to the map data of the second map depending on the maintenance status of the map data 60 provided in the map OTA server 5.

(2) In the method of difference comparison between the road information of the first map stored in the first map storage portion 71 of the navigation device 7 and the road information of the second map stored in the second map storage portion 21 of the map ECU 2, when the road information of the first map is compared with the road information of the second map and the road information corresponding to the road of the first map does not exist in the second map storage portion 21, there is a possibility that the road existing in the first map does not exist in the second map storage portion 21 but is newly registered in the latest map data 60 stored in the auxiliary storage device 53 of the map CIA server 5. Therefore, in the second map, a segment including a road different from the first map is selected as an update point.

In the comparison between the road information of the first map and the road information of the second map, for example, identifiers of the road information may be searched in ascending order and compared. Based on the position of the own vehicle and the frequently used area collected by a predetermined method, road information around the own vehicle may be preferentially searched and compared in order. By prioritizing and comparing road information included in the first map and the second map, it is possible to acquire the latest high-precision map data which is an area having a high use frequency and may be newly prepared. Therefore, the opportunity to use the latest map in the automatic driving ECU 4 can be increased.

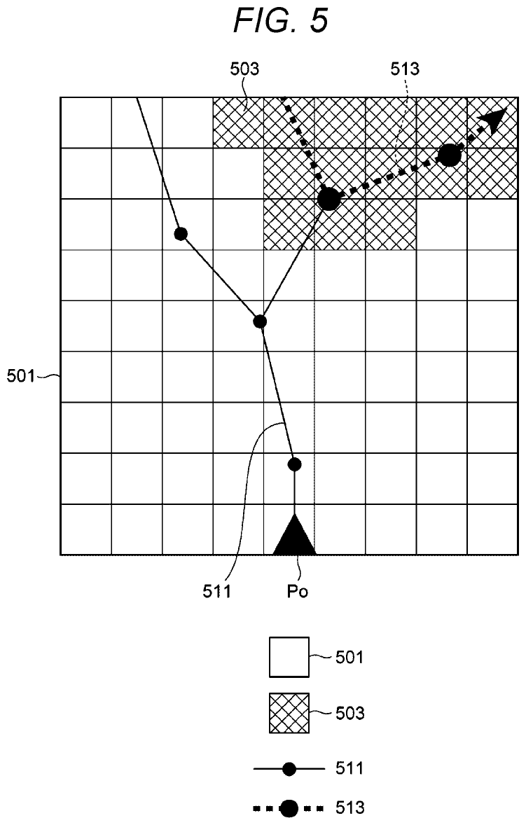

FIG. 5 illustrates an example in which an update target is selected by difference comparison between the road information of the first map stored in the first map storage portion of the navigation device 7 and the road information of the second map stored in the second map storage portion 21 of the map ECU 2.

In FIG. 5, a thin solid line 511 indicates a road existing in both the first map and the second map, and a broken line 513 indicates a road existing only in the first map. A segment 501 is obtained by dividing a map into a predetermined range, and a segment 503 is a segment in which map data is not recorded in the second map storage portion 21 and is selected as an update point.

The segment 503 is a segment that is not selected as an update target only with the road information configured by the high-precision map data generated by the second map storage portion 21 illustrated in FIG. 5. However, according to the present embodiment, the map update portion 22 refers to the road information in the map data of the first map stored in the first map storage portion, so that the road information is selected as an update target part. That is, a segment including an unrecorded road that exists on the first map stored in the first map storage portion and does not exist on the second map stored in the second map storage portion 21 is selected.

Then, when the road information of the corresponding second map is stored in the map data 60 stored in the auxiliary storage device 53 of the map OTA server 5, the second map is updated by the map update portion 22, and new road information can be added to the second map storage portion 21. Therefore, the opportunity to use the latest map in the automatic driving ECU 4 can be increased.

A map providing system according to the present embodiment includes a vehicle system mounted on a vehicle 1, and a map OTA server 5 that provides a second map in accordance with a request from the vehicle system. The vehicle system includes a map management portion (map ECU 2) that repeatedly updates information on the second map based on a result of comparison between the first map and the second map stored in a first map storage portion 71 and a second map storage portion 21, a travel control portion (automatic driving ECU 4) that controls travel of the vehicle, and a communication portion (communication unit 3) that controls communication with the outside of the vehicle. Then, the map ECU 2 (map update portion 22) selects a predetermined range as an update point at which the map data is to be updated (the number of a segment to be updated) based on a result of comparison between the first map and the second map.

The update point of the second map is selected based on road information or route information, and map data (segment) included in the selected update point is requested to the map OTA server 5. In this manner, by specifying a range that is included in the first map storage portion 71 of the navigation device 7 but is not included in the second map storage portion 21, it is possible to preferentially update the latest map data of a range that is not included in the map ECU 2 and is likely to be included in the map OTA server 5 (a place where a high precision map prepared for automatic driving is likely to be newly prepared). Therefore, in the map of the map ECU 2, the unrecorded range can be preferentially kept up to date, the opportunity to use the latest map can be increased, and the application (for example, automatic driving or driving support) using the map data can be utilized to the maximum.

Further, the present invention is not limited to the above-described embodiments. Various modifications and equivalent configurations may be contained within the scope of claims. For example, the above-described embodiments are given in detail in order to help easy understating of the present invention. The present invention is not limited to be provided all the configurations described above. In addition, some of the configurations of a certain embodiment may be replaced with the configuration of the other embodiment. In addition, the configurations of the other embodiment may be added to the configurations of a certain embodiment. In addition, some of the configurations of each embodiment may be added, omitted, or replaced with respect to the configuration of the other embodiment.

In addition, the above-described configurations, functions, processing units, and processing means may be realized by a hardware configuration by setting some or all of the configurations using an integrated circuit, or may be realized by a software configuration by analyzing and performing a program to realize the functions by the processor. The information of the program realizing functions, tables, and files may be stored in a memory device such as a memory, a hard disk, a Solid State Drive (SSD) or a recording medium such as an IC card, an SD card, and a DVD. In addition, only control lines and information lines considered to be necessary for explanation are illustrated, but not all the control lines and the information lines necessary for mounting are illustrated. In practice, almost all the configurations may be considered to be connected to each other.

Hitherto, the embodiments of the invention have been described, but the invention is not limited to the embodiments. Various modifications may be made within a scope not departing from the spirit of the invention disclosed in claims. For example, the above-described embodiments of the invention have been described in detail in a clearly understandable way, and are not necessarily limited to those having all the described configurations. In addition, some of the configurations of a certain embodiment may be replaced with the configurations of the other embodiments, and the configurations of the other embodiments may be added to the configurations of the subject embodiment. In addition, some of the configurations of each embodiment may be omitted, replaced with other configurations, and added to other configurations.

Reference Signs List

1 vehicle

2 map ECU

3 communication unit

4 automatic driving ECU

5 map OTA server (management device)

21 second map storage portion

22 map update portion

23 communication portion

24 map output portion

25 positioning unit

26 route generation portion

71 first map storage portion

1. A map providing system that provides map data, the map providing system comprising:
a first map storage portion that stores a first map;
a second map storage portion that stores a second map; and
a map update portion that updates the second map stored in the second map storage portion when update data is provided from a management device that manages update data of the second map, wherein
the map update portion selects an update point to update map data on the second map based on a difference obtained by comparing the first map stored in the first map storage portion with the second map stored in the second map storage portion, and requests the management device to provide update data of the selected update point.

2. The map providing system according to claim comprising
a route information acquisition portion that acquires information of a route on a first map set by using the first map, wherein
the map update portion compares the route on the first map with a road on the second map stored in the second map storage portion, and when a road constituting the route on the first map does not exist in the second map stored in the second map storage portion, a range including the road that does not exist is selected as the update point.

3. The map providing system according to claim 2, wherein the map update portion compares identification information of a road constituting the route with identification information of a road existing in the second map stored in the second map storage portion, and when the identification information of the road constituting the route does not exist on the second map stored in the second map storage portion, selects a range including the road that does not exist as the update point.

4. The map providing system according to claim 2, wherein the map update portion selects a range including a branch road or a junction road as the update point based on information on a branch point and a junction point in the route.

5. The map providing system according to claim 1, wherein the map update portion compares a road on the first map with a road on the second map stored in the second map storage portion, and when at least a part of the road on the first map does not exist on the second map stored in the second map storage portion, selects a range including the part of the road that does not exist as the update point.
